(19) United States
(12) Patent Application Publication
(10) Pub. No.: US 2016/0024369 A1
(43) Pub. Date: Jan. 28, 2016

(54) METHOD OF REDUCING FRICTIONAL LOSSES IN OIL AND GAS WELL DRILLING

(71) Applicants: Amir A. MIRZAEI, Toronto (CA); Hirbod RAD, Calgary (CA)

(72) Inventors: Amir A. MIRZAEI, Toronto (CA); Hirbod RAD, Calgary (CA)

(21) Appl. No.: 14/743,023

(22) Filed: Jun. 18, 2015

Related U.S. Application Data
(60) Provisional application No. 62/015,080, filed on Jun. 20, 2014.

(30) Foreign Application Priority Data
Jun. 20, 2014 (CA) 2854748

(51) Int. Cl. C09K 8/36; C09K 8/82

(52) U.S. Cl. CPC C09K 8/36; C09K 8/82; C09K 2208/28

(57) ABSTRACT

Fluids for use within a wellbore are provided, comprising amorphous polyalphaolefins (APAO), copolymers of alphaolefins and styrene (APAO-S), terpolymers of alphaolefins and styrene and butadiene (APAO-SB) and/or amorphous polyisobutylene (APIB) and copolymers of polyisobutylene and styrene (APIB-S) and terpolymers of polyisobutylene and styrene and butadiene (APIB-SB) in an oil-based hydrocarbon solvent. Novel properties of such fluids are described, and the fluids may be used, for example, during drilling or fracturing operations.

### CROSS REFERENCE TO RELATED APPLICATIONS

This application claims the benefit of U.S. Provisional Application No. 62/015,080 filed Jun. 20, 2014, the entire contents of which are incorporated herein by reference.

### FIELD OF THE INVENTION

The present invention relates generally to reducing frictional losses, reducing frictional and turbulence induced drag and rotating torque in the rotary drilling of oil and gas wells while drilling with oil based or invert emulsion drilling fluids or oil based fracturing fluids. More particularly, the present invention relates to the incorporation of specific polymeric substances in invert emulsion or oil based drilling fluids and oil based fracturing fluids for the use in the friction and drag reduction of these fluids.

### BACKGROUND OF THE INVENTION

In the field of drilling, completion, and workover of oil and gas wells, various fluids are formulated for use in different circumstances and types of formations. For example, drilling fluids may vary in composition over a wide spectrum and are formulated to maintain pressure, cool drill bits, and lift cuttings from the borehole. Fracturing fluids are formulated to stimulate the formation through artificially induced fractures. Generally, drilling or fracturing fluids are based on aqueous formulations or oil-based formulations.

Typical oil-based drilling fluids may include additives such as emulsifying agents, wetting agents, water, fluid-loss additives or fluid-loss control agents, weighting agents, and gelling or viscosifying agents (for example organophilic clays). These formulations perform adequately in a number of applications, and the formulation may be adjusted based on the stability of the formation in which drilling is taking place. Oil-based fluids are particularly useful in shale formations, where the use of conventional water-based drilling fluids could result in the deterioration and collapse of the shale formation. The use of oil-based formulations circumvents this problem.

One of the objectives of a drilling fluid is to reduce friction or provide a lubricating medium for the drill bit and the drill pipe to work in while drilling the well bore.

Friction is normally defined as a relative resistance to motion of touching surfaces. In the drilling of well bores, friction must be overcome by lubricating and thus enabling the surfaces which are creating undesirable friction to appropriately more or glide over one another. Some materials which are presently being considered as friction reducing materials for use with oil based drilling fluids to help in reducing friction are various lubricating oils, detergents, clays, alcohols, gilsonite, asphaltic materials, cellulose materials, various polymeric compounds, dextrose materials, glycerins and amines.

In the process of transferring liquids by fluid flow, it is well known that energy must be expended to overcome friction encountered in the movement of the liquid. When a fluid is pumped under pressure, this loss is generally apparent as a pressure drop along the conduit. Such pressure drops are particularly large under conditions wherein the liquid velocity has exceeded the critical limit for smooth laminar flow. The problem of high friction loss caused by non-laminar flow is frequently met in industrial operation where high fluid velocities are essential, such as in oil well drilling and fracturing operations.

To compensate for this friction loss, considerable energy must be expended. Obviously, a reduction in friction loss would permit lower operating pressures and reduced power requirements. Thus, a method whereby the friction loss in the flow of hydrocarbon liquids can be appreciably reduced is desired.

During the drilling operation, the rate at which the hole can be made depends in part upon the rate of rotation of the drill pipe and upon the “weight on bottom” or force with which the drill bit acts on the bottom of the hole. This force is controlled by addition to drill collars which are pipes of larger diameter and greater mass than drill pipe. It is, therefore, desirable to minimize friction upon the drill string and maximize horsepower at the bit.

High rotational friction or high drag friction in removing a string of drill pipe miles in length for the purpose of periodically changing bits can severely limit the ability and efficiency of a given derrick to drill deep wells and also increases the cost of drilling.

In present day drilling, there are areas where basic rig overhead costs are $50,000 or more per day. It is, therefore, economically desirable to drill as rapidly as possible with minimum equipment and power.

The friction of running pipe into and out of the hole, the increases in torque and power to rotate the drill pipe, the wear and stress on drill pipe and danger of twist offs of the drill pipe has caused numerous drilling fluid friction reducers to be investigated.

The prior art shows such friction reducing drilling additives to be composed of saturated or unsaturated fatty acids, mixtures of fatty acids and resin acids, naturally occurring triglycerides, stearates of aluminum and other metals, fatty amides, sulfurized vegetable oils, sulfated fatty acids and fatty alcohols and mixtures thereof and their solutions or emulsions in water or primary alcohols of 12 to 15 carbon atoms.

In general, all sorts of soft solids including graphite, blown asphalts, gilsonite, soaps, plastics (such as polyethylene or Teflon particle dispersions), have been proposed as drilling fluid lubricants. A wide variety of such substances that have a known performance history as boundary or hydrodynamic friction reducers in industry have been introduced as drilling fluid friction reducing additives, as for example in U.S. Pat. Nos. 2,773,030; 2,773,031; 3,014,862; 3,027,324; 3,047,493; 3,047,494; 3,048,538; 3,214,374; 3,242,160; 3,275,551; 3,340,188; 3,372,112; 3,377,276; and 3,761,410.

The 1977-78 Guide to Drilling, Workover and Completion Fluids, Gulf Publishing Company, Houston, Tex., lists some 62 proprietary drilling fluid friction reducing additives offered by various drilling fluid additive suppliers. All of these compounds, composed of the above cited oils and soft solids lubricating materials, attest to the interest in, and need for, practical and effective means of reducing frictional and turbulence induced drag and rotating torque in the rotary drilling of wells.

Regardless of the effectiveness of a drilling fluid friction reducing additive in reducing friction in a laboratory friction test or in the field, the additive can be useful only if it meets criteria of practicality. It must not impair necessary drilling fluid properties of chemical or physical nature.

### SUMMARY OF THE INVENTION

In accordance with a first aspect of the invention, there is provided an oil-based fluid for use within a wellbore, the fluid comprising: 50 to 100% by volume of a hydrocarbon-based oil; 0 to 50% by volume of water; and from 0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB) each having an average molecular weight of ranging from 500 and 50,000,000.

Preferably, the APAO-S contains between 0 to 99% polymerized styrene (or styrene as the building block of copolymer). Also preferably, the APAO-SB contains between 0-99% polymerized styrene and/or between 0-99% polymerized butadiene as parts of terpolymer.

Preferably, the hydrocarbon-based oil comprises at least one of the following: paraffinic hydrocarbons, aromatic hydrocarbons, and naphthenic hydrocarbons. Also preferably, the hydrocarbon-based oil comprises up to 50% by volume at least one of the following: non-solvent alcohols, vegetable oils and synthetic fluids.

Preferably, the concentration of APAO or APAO-S or APAO-SB ranges from about 0.1 ppm and about 10,000 ppm. More preferably, the average molecular weight of APAO or APAO-S or APAO-SB ranges from about 50,000 and 10,000,000.

According to an embodiment of the invention, the oil-based fluid further comprises an amount of amorphous polyisobutylene (APIB) and copolymers of polyisobutylene and styrene (APIB-S) and terpolymers of polyisobutylene and styrene and butadiene (APIB-SB) having an average molecular weight ranging from 500 and 50,000,000. Preferably, the APIB-S contains up to 99% of polymerized styrene. More preferably, APIB-SB contains up to 99% of polymerized styrene and between 0-99% of polymerized butadiene as parts of the terpolymer.

According to an embodiment of the invention, the oil-based fluid is formulated for use as a drilling fluid. Preferably, the fluid comprises up to 100% by volume of hydrocarbon-based oil.

According to an embodiment of the invention, the fluid further comprises at least one of the following: a weighting material, a wetting agent, a fluid loss additive agent; and an emulsifier.

According to another embodiment of the invention, the fluid is formulated for use as a fracturing fluid. Preferably, the fluid comprises up to 100% of the hydrocarbon-based oil (by volume).

According to another aspect of the invention, there is provided an oil-based fluid for use within a wellbore, the fluid comprising: 50 to 100% hydrocarbon -based oil (by volume); 0 to 50% water (by volume); and 0.1 ppm to 100,000 ppm of a compound selected from the group consisting of: amorphous polyisobutylene (APIB); copolymers of polyisobutylene and styrene (APIB-S); and terpolymers of polyisobutylene and styrene and butadiene (APIB-SB) having an average molecular weight of between 500 and 50,000,000. Preferably, the hydrocarbon-based oil comprises a compound selected from the group consisting of: paraffinic hydrocarbons, aromatic hydrocarbons, or naphthenic hydrocarbons. More preferably, the hydrocarbon-based oil comprises up to 50% by volume of non-solvent alcohols, vegetable oils or synthetic fluids. Preferably, the concentration of APIB and/or APIB-S and/or APIB-SB ranges from about 0.1 ppm to about 100,000 ppm. Preferably according to another embodiment, the average molecular weight of APIB and/or APIB-S and/or APIB-SB ranges from about 50,000 to about 10,000,000.

According to an embodiment of the invention, the fluid is formulated for use as a drilling fluid. Preferably, the fluid comprises up to 100% by volume of a hydrocarbon-based oil. Preferably, the fluid further comprising a compound selected from the group consisting of: a weighting material; a wetting agent; fluid loss additives; lubricity additives; and emulsifiers. Preferably, the fluid is formulated for use as a fracturing fluid. Also preferably, the fluid comprises up to 100% by volume of a hydrocarbon-based oil.

According to another aspect of the present invention, there is provided a method for reducing friction and drag and drilling torque requirement and increasing the penetration rate of an oil-based drilling fluid and/or fracturing fluid comprising of: providing an oil-based drilling fluid; and 0.1 ppm to 100,000 ppm of a compound selected from the group consisting of: amorphous polyalphaolefins (APAO); copolymers of alphaolefins and styrene (APAO-S); and terpolymers of alphaolefins and styrene and butadiene (APAO-SB) each having an average molecular weight ranging from 500 to 50,000,000.

According to yet another aspect of the present invention, there is provided a method for reducing friction and drag and drilling torque requirement and increasing the penetration rate of an oil based drilling fluid, the method comprising: providing an oil-based drilling fluid; and 0.1 ppm to 100,000 ppm of a compound selected from the group consisting of: amorphous polyisobutylene (APIB); copolymers of polyisobutylene and styrene (APIB-S); and terpolymers of polyisobutylene and styrene and butadiene (APIB-SB) having an average molecular weight ranging from 500 to 50,000,000.

According to yet another aspect of the present invention, there is provided a method for reducing friction and drag of an oil based fracturing fluid, the method comprising: providing an oil-based fracturing fluid; and 0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB) each having an average molecular weight of ranging from 500 to 50,000,000.

According to another aspect of the present invention, there is provided a method for reducing friction and drag of an oil based fracturing fluid, the method comprising: providing an oil-based fracturing fluid; and 0.1 ppm to 100,000 ppm of a compound selected from the group consisting of: amorphous polyisobutylene (APIB); copolymers of polyisobutylene and styrene (APIB-S); terpolymers of polyisobutylene and styrene and butadiene (APIB-SB) each having an average molecular weight ranging from 500 and 50,000,000.

According to yet another aspect of the present invention, there is provided a method for reducing friction and drag of a fracturing fluid during fracturing treatment, the method comprising the steps of:

providing an oil based fracturing fluid; adding 0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB); amorphous polyisobutylene (APIB); copolymers of polyisobutylene and styrene (APIB-S); and terpolymers of polyisobutylene and styrene and butadiene (APIB-SB).

Other aspects and features of the present invention will become apparent to those ordinarily skilled in the art upon review of the following description of specific embodiments of the invention.

### DETAILED DESCRIPTION

Drag reducing agents based on amorphous polyalphaolefins (APAO), copolymers of alphaolefins and styrene (APAO-S), terpolymers of alphaolefins and styrene and butadiene (APAO-SB) of and/or amorphous polyisobutylene (APIB) and copolymers of polyisobutylene and styrene (APIB-S) and terpolymers of polyisobutylene and styrene and butadiene (APIB-SB) are provided for use in oil-based drilling and/or fracturing fluids.

The resulting fluids show reduced friction and drag under the same flow characteristics.

The types of polymers that are contemplated in the present invention comprise any of the (high molecular weight) amorphous oil-soluble polyalphaolefins (APAO), copolymers of alphaolefins and styrene (APAO-S), terpolymers of alphaolefins and styrene and butadiene (APAO-SB) of and/or amorphous polyisobutylene (APIB) and copolymers of polyisobutylene and styrene (APIB-S) and terpolymers of polyisobutylene and styrene and butadiene (APIB-SB) polyalphaolefins (APAO). Such polymers, and methods for their manufacture, have been previously described. For example, APAOs may be produced by homopolymerization or copolymerization of a-olefins (e.g. 1-butene, 1-hexene, 1-dodecene with Ziegler-Natta catalysts). These copolymers have an amorphous structure, which makes them useful for various other applications including but not limited to the production of hot melt adhesives. APAOs have been used as drag reducing agents for pipelines carrying crude and refined petroleum products.

Suitable hydrocarbon soluble polymers include but are not limited to material such as polyolefins, polyisobutylene, polydimethylsiloxane, polystyrene derivatives, polyacrylates, polybutadiene, polyisopreme, cyclopentene polymers and copolymers of cyclopentene with other ethylenically unsaturated hydrocarbons such as isobutene, octene, butadiene and isoprene. Particularly desirable high molecular weight polymers are non-crystalline, hydrocarbon soluble, polyalphaolefin homopolymers and copolymers in which the olefin monomers contains from 2 to 30 carbon atoms. All of the various high molecular weight polymers and their methods of preparation are well known in the art. For example, U.S. Pat. No. 4,493,903 to Mack, discloses a method for producing ultra-high molecular weight, oil soluble, non-crystalline polymers of alpha olefins.

The polyalphaolefin polymer may be formed using any method known to persons skilled in the art (such as, for example, using the methods disclosed in U.S. Pat. Nos. 3,692,676; 4,289,679; 4,358,572; 4,433,123; 4,493,903; 4,493,904, U.S. Pat. No. 4,384,089; U.S. Pat. No. 4,845,178; U.S. Pat. No. 4,837,249, and/or U.S. Pat. No. 5,449,732); In addition, amorphous polyisobutylene (APIB) may be used in accordance with the present description, in place of, or together with APAO. APIB or amorphous polyisobutylene products are currently available under the trade name OPPANOL from BASF in various molecular weights ranging from less than 40,000 to more than 5,000,000 as determined by GPC and in the form of slabs which must be processed prior to application; or from other suppliers under various trade names.

The presently described compounds (amorphous oil-soluble polyalphaolefins (APAO), copolymers of alphaolefins and styrene (APAO-S), terpolymers of alphaolefins and styrene and butadiene (APAO-SB) of and/or amorphous polyisobutylene (APIB) and copolymers of polyisobutylene and styrene (APIB-S) and terpolymers of polyisobutylene and styrene and butadiene (APIB-SB) polyalphaolefins (APAO)) primarily function as friction and drag reducing agents for oil-based drilling and fracturing fluids. That is, these polymers may be added to fluids used to drill or fracture the oil and gas producing formations, maintain pressure, cool drill bits, lift cutting from the boreholes in the drilling and fracturing operations for oil and gas wells.

The term “oil-based fluids” as used herein generally refers to fluids having a continuous phase of oil. Should another phase be present to form an emulsion, this other phase would be the discontinuous phase.

Hydrocarbon-based oils suitable for use as solvents with the presently described polymers comprise one or more of the following hydrocarbon solvents: paraffinic hydrocarbons, aromatic hydrocarbons, and naphthenic hydrocarbons. One or more of the oils or solvents may be synthetic.

Blends comprising one or more of said oils, and hydrocarbon based alcohol would also be suitable. The oil-based fluids may further contain alcohols, weighting agents, wetting agents, emulsifying agents, and other additives known in the art.

Suitable amorphous oil-soluble polyalphaolefins (APAO), copolymers of alphaolefins and styrene (APAO-S), terpolymers of alphaolefins and styrene and butadiene (APAO-SB) polymers for use in accordance with the present methods are homopolymers and/or copolymers derived from alpha olefin monomers. The polymers have an average molecular weight of about 500 to about 50,000,000, and preferably between about 5,000,000 and 25,000,000.

APAO, APAO-S, APAO-SB polymers are added to the oil-based solvent at concentrations of about 0.1 ppm of polymer to about 1,000 ppm of polymer, and preferably from about 5 ppm to about 100 ppm of polymer. Suitable APIB, APIB-S, APIB-SB polymer for use in accordance with the present methods have an average molecular weight from about 500 to about 50,000,000. Preferably, the polymers have a molecular weight from about 1,000,000 to about 5,000,000. APIB, APIB-S, APIB-SB is added to the oil-based fluids in accordance with the present methods, at concentrations from about 0.1 ppm to about 1000 ppm. Preferably, APIB is added at concentrations ranging from about 10 ppm to about 500 ppm.

The molecular weight and polymer concentration required for suitable results will depend on the oil-based hydrocarbon composition selected, and the flow regime during operation and pumping of the fluids. Such manipulations of the flow characteristics of down hole fluids based on operational requirements will be well within the ability of a person skilled in the art, when provided with the teachings of the present description.

A conventional oil-based drilling fluid formulation may include the following general ingredients: oil (generally various grades of diesel fuel, crude oil, or other distillate fractions), emulsifying agents, wetting agents, water or brine, fluid-loss additives or fluid-loss control agents, weighting agents, viscosifying agents including but not limited to APAO and APIB and, organophillic clays. Scavengers or Alkali may also be used, preferably lime (calcium hydroxide or calcium oxide), to bind or react with acidic gases (such as CO₂ and H2₅) encountered during drilling in the formation.

In preferred embodiments, the formulations comprise at least one of APAO, APAO-S, APAO-SB, APIB, APIB-S, APIB-SB polymers and oil.

Other solvents or additives may also be present. Typically, the drilling fluid is up to about 100% oil by volume.

The oil employed in the oil-based drilling fluid is generally a diesel fuel, but may be another commercially available hydrocarbon solvent or blend such as kerosene, fuel oils, selected distillate fractions or selected crudes.

Typical, but non-limiting, examples of suitable emulsifiers which can be readily employed are magnesium or calcium soaps of fatty acids. Typical, but non-limiting, examples of a suitable wetting agent which can be readily employed is an alkylaryl sulfonate. Typical, but non-limiting, examples of a weighting material which can be readily employed is barium sulphate and calcium carbonate. These additives and other are known in the art and readily available.

Fracturing fluids for use in accordance with the present invention may include any or all of APAO, APAO-S, APAO-SB, APIB, APIB-S, APIB-SB polymers, organic liquids such as diesel oil or other paraffinic, cyclic, aromatic liquids which can dissolve the subject polymers, polymeric viscosifiers, breaking agents and proppants.

Minimally, the present formulations comprise any or all of APAO, APAO-S,APAO-SB,APIB,APIB-S, APIB-SB polymers and a solvent. Other solvents or additives may also be present. Typically, the fracturing fluid is up to about 100% oil by volume.

The following non-limiting example depicts the performance of the subject drilling fluid:

Invert sample:
90:10 (Oil Water:Ratio)
30% CaCl2 Brine in the water phase
Lime: 10 kg/m3
Emulsifier Package: 10 L/m3
Organophilic Clay: 5 kg/m3
APAO-S Polymer: 100 ppm

FLOW LOOP DATA

| | Reynolds | measured | | Q | Q1 | P | P1 | | | P |
|---|---|---|---|---|---|---|---|---|---|---|
| Sample | No. | time (Sec) | ml/min | (L/min) | (L/min) | (PSI) | (PSI) | Q1-Q | P1-P | Decrease |
| RUN No. 1 | 4,780 | 166.5 | 520.52 | 32.05 | 32.45 | 13.95 | 12.82 | 0.4 | 1.13 | 8.10% |
| | 4,875 | 88.96 | 980.47 | | 33.1 | | 12.8 | 1.05 | 1.15 | 8.24% |
| | 4,942 | 122.48 | 1,458.29 | | 33.55 | | 12.71 | 1.5 | 1.24 | 8.89% |
| | 5,008 | 145.94 | 1,836.75 | | 34 | | 12.67 | 1.95 | 1.28 | 9.18% |
| | 5,096 | 128.3 | 2,087.12 | | 34.6 | | 12.73 | 2.55 | 1.22 | 8.75% |
| RUN No. 2 | 4,868 | 90.64 | 633.15 | 32.35 | 33.05 | 14.12 | 12.95 | 0.7 | 1.17 | 8.29% |
| | 4,897 | 92.07 | 938.30 | | 33.25 | | 12.83 | 0.9 | 1.29 | 9.14% |
| | 5,030 | 127.29 | 1,389.22 | | 34.15 | | 12.8 | 1.8 | 1.32 | 9.35% |
| | 5,133 | 97.69 | 1,818.68 | | 34.85 | | 12.75 | 2.5 | 1.37 | 9.70% |
| | 5,185 | 172.69 | 2,059.89 | | 35.2 | | 12.78 | 2.85 | 1.34 | 9.49% |
| RUN No. 3 | 4,890 | 162.97 | 538.61 | 32.3 | 33.2 | 14.09 | 12.95 | 0.9 | 1.14 | 8.09% |
| | 5,030 | 92 | 945.05 | | 34.15 | | 12.85 | 1.85 | 1.24 | 8.80% |
| | 5,163 | 126.65 | 1,399.31 | | 35.05 | | 12.81 | 2.75 | 1.28 | 9.08% |
| | 5,280 | 145.08 | 1,842.66 | | 35.85 | | 12.73 | 3.55 | 1.36 | 9.65% |
| | 5,347 | 129.85 | 2,070.77 | | 36.3 | | 12.73 | 4 | 1.36 | 9.65% |

The data supports that the addition of the fluid according to a preferred embodiment of the present invention reduces the pressure in the fluid (P₁-P) which results in an increase in fluid volume flow (Q-Q).

The above-described embodiments of the present invention are intended to be examples only. Alterations, modifications and variations may be effected to the particular embodiments by those of skill in the art without departing from the scope of the invention, which is defined solely by the claims appended hereto.

1. An oil-based fluid for use within a wellbore, the fluid comprising:
50 to 100% by volume of a hydrocarbon-based oil;
0 to 50% by volume of water; and
from 0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB) each having an average molecular weight of ranging from 500 and 50,000,000.

2. The oil-based fluid according to claim 1, where said APAO-S contains between 0 to 99% polymerized styrene (or styrene as the building block of copolymer).

3. The oil-based fluid according to claim 1, where said APAO-SB contains between 0-99% polymerized styrene and/or between 0-99% polymerized butadiene as parts of terpolymer.

4. The oil-based fluid according to claim 1, wherein the hydrocarbon-based oil comprises at least one of the following: paraffinic hydrocarbons, aromatic hydrocarbons, and naphthenic hydrocarbons.

5. The oil-based fluid according to claim 1, wherein the hydrocarbon-based oil comprises up to 50% by volume at least one of the following: non-solvent alcohols, vegetable oils and synthetic fluids.

6. The oil-based fluid according to claim 1, wherein the concentration of APAO or APAO-S or APAO-SB ranges from about 0.1 ppm and about 10,000 ppm.

7. The oil-based fluid according to claim 1, wherein the average molecular weight of APAO or APAO-S or APAO-SB ranges from about 50,000 and 10,000,000.

8. The oil-based fluid according to claim 1, further comprising an amount of amorphous polyisobutylene (APIB) and copolymers of polyisobutylene and styrene (APIB-S) and terpolymers of polyisobutylene and styrene and butadiene (APIB-SB) having an average molecular weight ranging from 500 and 50,000,000.

9. The oil-based fluid according to any one of claim 8, where said APIB-S contains up to 99% of polymerized styrene.

10. The oil-based fluid according to claim 8, where said APIB-SB contains up to 99% of polymerized styrene and between 0-99% of polymerized butadiene as parts of the terpolymer.

11. The oil-based fluid according to claim 1 that is formulated for use as a drilling fluid.

12. The fluid according to claim 11, comprising up to 100% by volume of hydrocarbon-based oil.

13. The fluid according to claim 11, further comprising at least one of the following: a weighting material, a wetting agent, a fluid loss additive agent; and an emulsifier.

14. The fluid according to claim 1, wherein said fluid is formulated for use as a fracturing fluid.

15. The fluid according to claim 14 comprising up to 100% of the hydrocarbon-based oil (by volume).

16. An oil-based fluid for use within a wellbore, the fluid comprising:
50 to 100% hydrocarbon-based oil (by volume);
0 to 50% water (by volume); and
0.1 ppm to 100,000 ppm of a compound selected from the group consisting of: amorphous polyisobutylene (APIB); copolymers of polyisobutylene and styrene (APIB-S); and terpolymers of polyisobutylene and styrene and butadiene (APIB-SB) having an average molecular weight of between 500 and 50,000,000.

17. The oil-based fluid according to claim 16, wherein the hydrocarbon-based oil comprises a compound selected from the group consisting of: paraffinic hydrocarbons, aromatic hydrocarbons, or naphthenic hydrocarbons.

18. The oil-based fluid according to claim 16, wherein the hydrocarbon-based oil comprises up to 50% by volume of non-solvent alcohols, vegetable oils or synthetic fluids.

19. The oil-based fluid according to claim 16, wherein the concentration of APIB and/or APIB-S and/or APIB-SB ranges from about 0.1 ppm to about 100,000 ppm.

20. The oil-based fluid according to claim 16, wherein the average molecular weight of APIB and/or APIB-S and/or APIB-SB ranges from about 50,000 to about 10,000,000.

21. The oil-based fluid according to claim 16, wherein said fluid is formulated for use as a drilling fluid.

22. The oil-based fluid according to claim 21 that is up to 100% by volume of a hydrocarbon-based oil.

23. The fluid according to claim 21, further comprising a compound selected from the group consisting of: a weighting material; a wetting agent; fluid loss additives; lubricity additives; and emulsifiers.

24. The oil-based fluid according to claim 16, wherein said fluid is formulated for use as a fracturing fluid.

25. The oil-based fluid according to claim 24 comprising up to 100% by volume of a hydrocarbon-based oil.

26. A method for reducing friction and drag and drilling torque requirement and increasing the penetration rate of an oil-based drilling fluid and/or fracturing fluid comprising of:
providing an oil-based drilling fluid; and
0.1 ppm to 100,000 ppm of a compound selected from the group consisting of: amorphous polyalphaolefins (APAO); copolymers of alphaolefins and styrene (APAO-S); and terpolymers of alphaolefins and styrene and butadiene (APAO-SB) each having an average molecular weight ranging from 500 to 50,000,000.

27. A method for reducing friction and drag and drilling torque requirement and increasing the penetration rate of an oil based drilling fluid, the method comprising:
providing an oil-based drilling fluid; and
0.1 ppm to 100,000 ppm of a compound selected from the group consisting of: amorphous polyisobutylene (APIB); copolymers of polyisobutylene and styrene (APIB-S); and terpolymers of polyisobutylene and styrene and butadiene (APIB-SB) having an average molecular weight ranging from 500 to 50,000,000.

28. A method for reducing friction and drag of an oil based fracturing fluid, the method comprising:
providing an oil-based fracturing fluid; and
0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB) each having an average molecular weight of ranging from 500 to 50,000,000.

29. A method for reducing friction and drag of an oil based fracturing fluid, the method comprising:
providing an oil-based fracturing fluid; and
0.1 ppm to 100,000 ppm of a compound selected from the group consisting of: amorphous polyisobutylene (APIB); copolymers of polyisobutylene and styrene (APIB-S); terpolymers of polyisobutylene and styrene and butadiene (APIB-SB) each having an average molecular weight ranging from 500 and 50,000,000.

30. A method for reducing friction and drag of a fracturing fluid during fracturing treatment, the method comprising the steps of:
providing an oil based fracturing fluid;
adding 0.1 ppm to 100,000 ppm of a compound selected from the group consisting of: amorphous polyalphaolefins (APAO); copolymers of alphaolefins and styrene (APAO-S); terpolymers of alphaolefins and styrene and butadiene (APAO-SB); amorphous polyisobutylene (APIB); copolymers of polyisobutylene and styrene (APIB-S); and terpolymers of polyisobutylene and styrene and butadiene (APIB-SB).
